(19) United States
(12) Patent Application Publication
(10) Pub. No.: US 2008/0261703 A1
(43) Pub. Date: Oct. 23, 2008

(54) Networked Gaming System With Ergonomic Gaming Machine Having Electromechanical Reels

(75) Inventors: Robert A. Luciano, Reno, NV (US); Thomas N. Taxon, Reno, NV (US); Kurt Spencer, Reno, NV (US); Timothy F. Kelley, Reno, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/112,295

(22) Filed: Apr. 30, 2008

Related U.S. Application Data
(63) Continuation-in-part of application No. 11/225,827, filed on Sep. 12, 2005.
(60) Provisional application No. 60/915,400, filed on May 1, 2007.
(60) Provisional application No. 60/685,157, filed on May 27, 2005.

(51) Int. Cl. A63F 9/24; A63F 13/00

(52) U.S. Cl. 463/46; 463/27

(57) ABSTRACT

A new ergonomic game cabinet with a unique layout is disclosed. The gaming machine cabinet includes a display mounted nearly vertically, combined with a player deck extending towards a player having more space at a more useful angle than previously available. The player deck will have open space usable by a player for small items (wallets, purses, chips, etc.), a player device area (typically buttons), and then a further area where a player can rest their arms, wrists, or elbows and comfortably reach the player device area. This further area may also be used for small player items, such as chips, tickets, etc. In addition, the new cabinet provides side panels on each side of the gaming machine cabinet that creates a feeling of being “surrounded” by the game experience due to reduced noise and visual distractions from nearby gaming machines, other patrons, waitrons, and the like. A version of the cabinet including electromechanical reels is also disclosed.

### CROSS-REFERENCE TO RELATED APPLICATIONS

This application claims the benefit of provisional application 60/915,400, filed May 1, 2007. This application is also a continuation-in-part and claims the benefit of co-pending U.S. patent application Ser. No. 11/225,827, filed Sep. 12, 2005, which claims the benefit of provisional application 60/685,157, filed May 27, 2005.

This application is related to U.S. patent application nn/nnn,nnn entitled “ERGONOMIC GAMING MACHINE HAVING ELECTROMECHANICAL REELS,” filed on Apr. 30, 2008, which claims the benefit of provisional application 60/915,400 filed on May 1, 2007 and is a continuation-in-part and claims the benefit of U.S. patent application Ser. No. 11/225,827, filed Sep. 12, 2005, which claims the benefit of provisional application 60/685,157, filed May 27, 2005.

This application is also related to U.S. patent application nn/nnn,nnn entitled “METHOD OF PROVIDING AN ERGONOMIC GAMING MACHINE HAVING ELECTROMECHANICAL REELS,” filed on Apr. 30, 2008, which claims the benefit of provisional application 60/915,400 filed on May 1, 2007 and is a continuation-in-part and claims the benefit of U.S. patent application Ser. No. 11/225,827, filed Sep. 12, 2005, which claims the benefit of provisional application 60/685,157, filed May 27, 2005.

All of the above referenced applications are hereby incorporated by explicit reference in their entireties for all purposes

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

This invention pertains generally to gaming machine cabinets found in establishments such as Nevada-style and Amerindian casinos, Amerindian bingo halls, and the like. More particularly, the present invention discloses a novel ergonomically designed gaming machine.

2. Description of the Related Art

Gaming machine cabinets have had certain traditional or standard configurations, typically categorized as one of uprights, slat tops, or bar tops. These machines are found in casinos, Amerindian bingo halls, bars, and the like. Examples of upright gaming cabinets with top boxes are seen in US Design Pat. D458,971 and D496,407. U.S. Pat. No. 6,820,875 shows an upright style gaming cabinet which has been divided into a system component box and a monitor box. U.S. Pat. No. 5,813,914 shows a typical slant top gaming machine combined with a top box. Bar top machines typically have flat, or slightly upraised, upper surfaces where the player views the screen looking down through a glass top or cover. This allows for the constant cleaning needed in a bar environment, as well as the need for waitrons and customers to reach over the gaming machine for drinks, food, etc.

Upright cabinets have a main display device centered in the upper body of the cabinet, below which is a player control area. The control area is attached so as to slope down and forward from the display area. The control area is just large enough for the controls (usually a button deck), typically being 4″-6″ proud of the display. Some uprights add a small bolster in front of the control area continuing at a downward slope to providing some hand support, but no arm support (see, e.g., U.S. Pat. No. 6,886,896, FIG. 2, or US Pat. D450,094). This configuration requires the player to sit either straight up or to lean back, away from the gaming machine (see, e.g., U.S. Pat. No. 6,638,166). A player sits in an erect position with very little (or no) back support and no arm support, with their arms and hands extended toward the control area controls while assuming a “lean-back” posture. When this is done for extended periods of time, player discomfort takes over and a player may be induced to “take a break” from play in order to stretch or relax. It is often at this juncture that a player will assess his current situation and decide to leave a machine in favor of another or to leave the casino altogether.

Slant top machines typically have a cabinet where the player display area includes a video monitor such as a CRT or LCD display that slants up and away from the player. The angle between horizontal and the display started out around 15 degrees, and has been moved gradually to about 30 degrees. The typical slant top slot machine has a control area in front of the slanted display, and often includes a molded single-level armrest that provides a player with some wrist support. Players at such a machines sit in a slumped forward position with their head and neck facing downward (towards the slanted display), and wrists on the gaming machine. When this is done for extended periods of time, player discomfort in the shoulders and neck results and a player may be induced to leave.

Gaming machines are usually positioned less than one foot from adjacent machines. Some units are often closer together with some installations using machines that actually touch one another. Players are often distracted by the sound and images from nearby games, which, if attractive enough, sometimes draw them away from the game they are playing. These distractions serve to minimize “seat time,” the time a player spends playing a particular gaming machine without interruption. In some cases, a player who has left a slot machine is actually enticed to leave the casino or to participate in another activity less profitable for the establishment. In addition, the close proximity of the existing game cabinets do not allow any form of security for personal items.

Efforts to correct the shortcomings of existing gaming machine designs have been limited to alternate foot arrangements (e.g., U.S. Pat. No. 6,637,844) and alternate player input device placement (e.g., U.S. Pat. No. 6,638,166). There is further need for improved ergonomics in gaming machines.

### SUMMARY OF THE INVENTION

Disclosed herein is a gaming machine that has a novel ergonomic cabinet design. The new design includes a monitor that is substantially vertical (less than a 30 degree incline from absolute vertical), a plurality of electromechanical reels and a player deck or player area that extends outward from the cabinet's front. The player deck includes an area for player input controls, space for smaller personal items, and space for a player to comfortably rest their arms, elbows, or wrists as the play games. The deck is configured to allow a player to play games while leaning into the gaming machine (inclined forward), if they choose. This is extremely novel compared to existing cabinets with substantially upright displays, where a player has to lean back (away from the machine) in order to shift positions.

One embodiment of the player deck will be substantially horizontal, but that is not a requirement. There are numerous ways of providing an area that is usable to place small personal items which is not flat and may not be strictly horizontal when viewed from the side. The ergonomic and useful player advantages may be embodied in any design which provides a player area where small items can be placed so that they are stable (won't roll onto the floor). The stable area may comprise a portion of the player deck instead of all of it.

In addition to the player deck having enough depth to properly distance the player's eyes from the monitor and to allow comfortable resting of body parts on the player deck, side panels are provided that block peripheral vision and some noise. The side panels may also be used to channel sound from the gaming machine, further engulfing a player in the gaming experience.

The side panels and player deck also provide security for personal items not previously found in gaming machines. When personal items are placed within the playing area, it becomes more difficult for a passerby to casually take personal items from a player. To take a personal item on the player deck and between the side panels will pose a greater difficulty for a potential thief seeking to steal from the player. This will effectively discourage subtle or passive thieving. Additionally, the partially enclosed design provides players with a feeling of ownership of their own personal area and a more secure setting for the entry of PIN codes and handling of money, making it more difficult for casual observers to discern players entering PIN codes and the like.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of a gaming cabinet in accordance with one embodiment of the present disclosure.

FIG. 2 is a top view of a gaming cabinet in accordance with one embodiment of the present disclosure.

FIGS. 3A-3B illustrate display angle in accordance with one embodiment of the present disclosure.

FIGS. 4A-4B illustrate perspective and side-views of a further embodiment of a gaming cabinet in accordance with one embodiment of the present disclosure.

FIG. 5 illustrates steps in providing a gaming cabinet in accordance with one embodiment of the present disclosure.

FIG. 6 is a perspective view of a gaming cabinet in accordance with one embodiment of the present disclosure.

FIG. 7 is a block diagram of a portion of the physical and logical components of the example gaming machine embodiments of FIGS. 1 and 6 relating to a gaming machine motherboard.

FIG. 8 is a diagram of a network of gaming machines in accordance with one embodiment of the invention.

FIG. 9 illustrates an example gaming machine with top box in accordance with one embodiment of the invention.

FIG. 10 illustrates another example gaming machine with top box in accordance with one embodiment of the invention.

FIG. 11 illustrates a third example gaming machine with top box in accordance with one embodiment of the invention.

### DETAILED DESCRIPTION OF THE INVENTION

Persons of ordinary skill in the art will realize that the following description of the present invention is illustrative only and not in any way limiting. Other embodiments of the invention will readily suggest themselves to such skilled persons having the benefit of this disclosure.

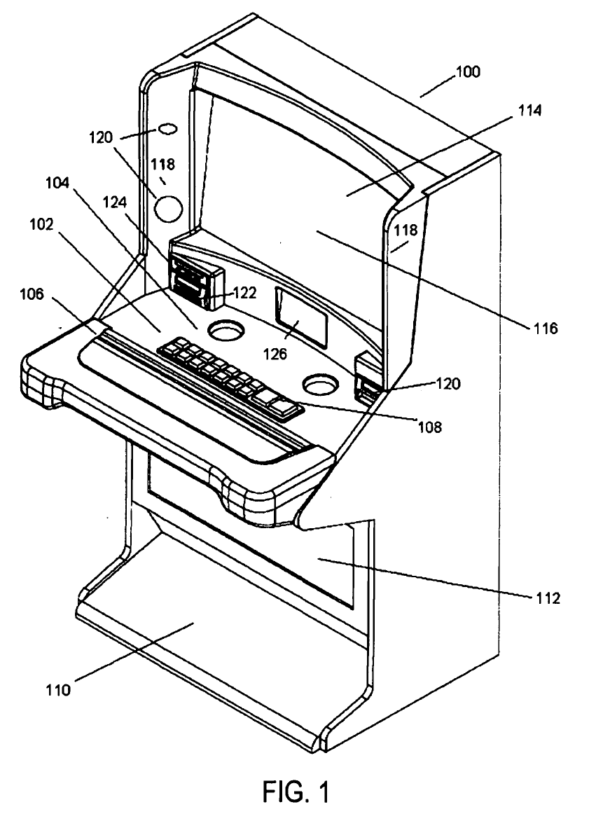

Referring to the drawings, for illustrative purposes the present invention is shown embodied in FIGS. 1 through 6. It will be appreciated that the apparatus may vary as to configuration and as to details of the parts without departing from the novel concepts disclosed herein. Methods may vary as to details, partitioning, repetition, step inclusion, and the order of the acts, without departing from the novel concepts disclosed herein.

Referring now to FIG. 1, the gaming machine cabinet 100 includes player control area 102 (shown as a button deck, but can be any player input devices) with flat area or player deck 104. Player deck 104 may be used for drinks, ashtrays, food and any personal items that would be convenient to place in easy reach such as wallets, money, gaming chips, or pocketbooks. Armrest 106, shown as a stepped armrest, allows resting of arms, elbows and/or wrists while maintaining finger access to player input devices 102, players' possessions in player deck 104, and any other areas on or near the frontal area of gaming machine 100. Armrest 106 may be any configuration intended to enable comfortable resting of elbows, forearms, and wrists, etc. Gaming machine 100 enables this novel layout due to the space provided between the front of screen 114 to the outer edge of armrest 106. In one embodiment this distance measures approximately 24 inches, with almost 17 inches of that space usable by a player (this includes player input area 102, player deck 104, and armrest 106). In the embodiment shown the areas are substantially flat, but other embodiments are fully contemplated such as having armrest 106 at varying angles relative to player deck 104, button deck 102 at varying angles relative to player deck 104, and player deck 104 in any configuration that provides the needed space to allow comfortable resting of arms, elbows, or wrists on the player deck bolster or armrest while interacting with the game input devices, and preferably allowing placement of small personal items. The player deck needs to have enough depth to allow, and preferably encourage, a slightly forward leaning position while using the gaming cabinet.

Also shown are typical gaming machine peripherals including bill acceptor 120, printer 122, card reader 124, and player tracking system and display 126 (preferably Bally Gaming And Systems' iView™ product). These devices are placed so that a player can see and, in most cases, operate them while resting his/her arms and/or wrists on armrest 106 of cabinet 100. Any set of gaming peripherals may be used with the gaming machine disclosed herein; shown is one exemplar embodiment.

Above player deck 104 is large color display 114. In one embodiment the display will be a DTV flat panel display having an aspect ratio of 16×9, such as 32″ LCD widescreen display mounted in landscape mode (positioned with its longer axis parallel to the deck areas). The flat panel display is preferably a high resolution LCD display, although lower resolutions may be used. Also illustrated is touch screen 116. Any touch screen technology may be used, for example, a controller and touch screen manufactured by MicroTouch. The preferred embodiment of display 114 uses flat panel display technology (any type of flat panel technology may be used), as their use allows the gaming machine to have an overall depth, front-to-back, similar to gaming machines already in use. This gives the ergonomic cabinet described herein a footprint approximately equal to gaming machines already on casino floors. In various embodiments, the display make take the form of flat-panel displays in the form of, but not limited to, liquid crystal, plasma, electroluminescent, vacuum fluorescent, field emission, or any other type of panel display known or developed in the art. Although preferred, it is not required to make use of the ergonomic designs disclosed herein.

A wide display using DTV's aspect ration of 16×9, such as a 26″ LCD or 32″ LCD widescreen flat panel display, has several advantages. It allows for simultaneous display of pay tables with the normally sized game play displays, reducing the need for a player to switch to help screens. A wide display can be logically divided into two or more viewing areas that can be used for showing different images. One viewing area will always include the primary game while the others can include the aforementioned pay tables and/or bonus games, player tracking information, special promotions, or just entertaining visual sequences. A wide screen also has the desirable trait of consuming significantly more of a player's peripheral vision than a standard screen, reducing visual distractions from the sides.

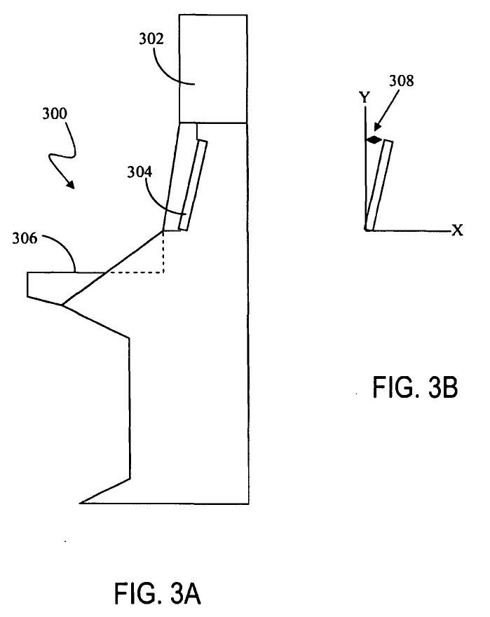

In one embodiment display 114 is slightly angled from vertical. Looking now at FIG. 3A, shown is gaming machine 300 with top box 302 and substantially flat player deck area 306. Also shown is angled display 304 (although shown with solid lines, the display is behind the end panels of gaming machine 300). Angled display 304 is shown projected out of gaming machine 300 with its inclination angle indicated by diamond 308 in FIG. 3B. In one embodiment, the inclination angle is set at 4 degrees. It is expected that the inclination angle will typically be set from 0 degrees to 20 degrees, with most embodiments between 4 and 7 degrees. The inclination angle helps with anti-glare, as well as accommodating players having differing torso lengths and the occasional player who plays while standing.

This allows a player to rest their arms on the player deck area and look slightly down at the screen while seated, the inclination of the screen matching a natural inclination of the head in a restful position with arms resting on the player deck. This prevents neck and eye strain and makes it easy (comfortable) to make use of the screen. The display is set back from the player deck/control deck area at an ergonomically sound visual distance which allows a player to lean slightly forward and be both comfortable and completely immersed in the game. These factors all help a player to tune-out distractions from any nearby activity, such as a passing patrons and waitrons and nearby games.

Returning to FIG. 1, peripheral vision distractions are further reduced by side panels or wings 118. Wings 118 help visually enclose the player so they can be engulfed by the game experience. In some embodiments wings 118 will be substantially flat, while in other embodiments wing 118 will have an internal dimension that encloses audio projection devices 120. In some embodiments the speakers are mounted inside the gaming machine cabinet 100 and one or more audio channels are used to carry the sound to openings in the wings 118. In other embodiments additional audio input devices (not shown) in the form of one or more microphones and output devices in the form of speakers or similar projection devices may be coupled to the gaming machine for the purposes of actively cancelling out distracting sounds from the surrounding environment using “cone of silence,” “beamed” sound or wave cancellation techniques. For example, samples taken from microphones positioned at various places on the cabinet 100 will be analyzed along with sounds known to be emanating from the game itself. Appropriate inverted signals will be issued from the sound cancellation devices to help prevent auditory player distractions.

Foot rest 110 is lower and flatter (7 to 10 degrees) than on existing gaming machine cabinets, promoting a forward leaning position rather than the typical backward lean of traditional upright gaming machines (traditional upright gaming machine footrests are angled around 25 degrees). In some embodiments, the foot rest 110 is illuminated for safety and security. An illuminated graphic area 112 may also be provided below armrest 106 providing enhanced security for items the player may position near her/his feet.

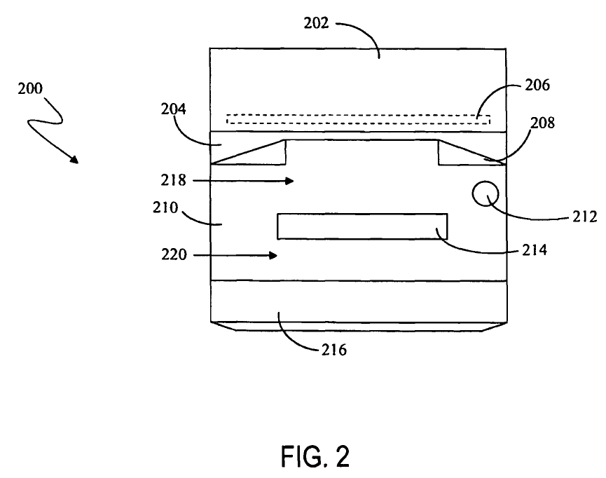

Continuing on with FIG. 2, shown is a schematic top view of gaming cabinet 200. 202 is the top of the cabinet, and 206 represents the monitor inside the cabinet. The player input deck or input area is area 214, with a first deck or player area generally indicted by 218, and a second player deck or player area generally indicated by 220. The entire deck is indicated as player deck 210, with cup-holder 212 in player area 218. Bolster or armrest 216 is expected to be a resilient, firm but pliable moulding attached to the front of player deck 210 and being a part of player deck 210. Moulding 208 (one on each side, as shown) is designed to contain bill acceptors, ticket printers/readers, players card readers, and similar I/O devices. Bezel 204 is designed to help draw a player's attention to the screen, in one embodiment being black and sloped from the outer edge of the cabinet to the edge of screen.

The top view of gaming machine cabinet 200 illustrates one aspect of the novel layout of the cabinet. Screen 206 is mounted vertically or at a slight angle, and is set back from the outer edge of bolster 216 by a substantial distance. In one embodiment, this distance is approximately 24″, with the player deck (with bolster) being approximately 17″ in depth. This novel arrangement, including a vertical or near-vertical screen with a player's deck having substantial distance between the screen and the edge of the bolster, provides significant ergonomic improvements for players.

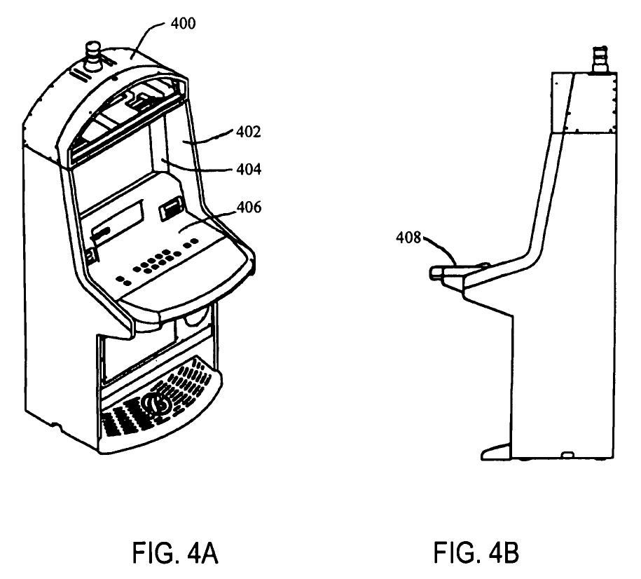

FIGS. 4A-4B show another embodiment of a gaming machine in accordance with this disclosure. Shown is optional top box 400. Side panels or wings 402 are shown in a slim embodiment. These do not enclose sound projection devices, as disclosed in FIG. 1. Screen bezel 404 helps draw attention to the screen by being a dark color and being slanted in towards the screen from wing 402. Preferably all four sides of the screen will have similarly designed bezels.

Player deck 406 is molded as a single piece, including the upward extending portion near the screen enclosing player input devices such as bill acceptors, ticket printers/readers, player card readers, and the like. Player deck 406 then becomes substantially flat, extended away from the screen to the outer edge of the molded bolster. The substantially flat section is preferably 12″ or longer.

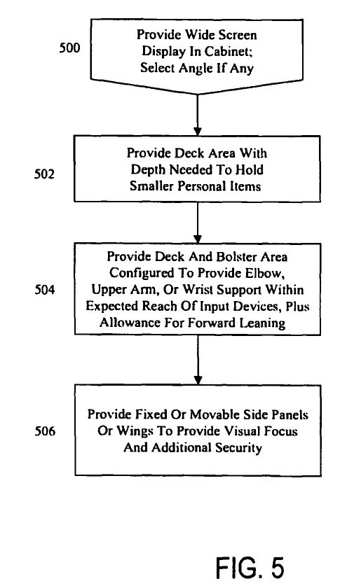

FIG. 5 illustrates novel aspects of the cabinet disclosed herein. Box 500 corresponds to the actions necessary to provide a wide screen display in the upper portion of a gaming cabinet, operably connected to internal logic devices to allow game play thereon. Included in the actions is mounting the wide screen with 0 to 10 degrees of tilt from vertical; one embodiment has 4-5 degrees of tilt. The screen is preferably an LCD high resolution display having an aspect ration of 16×9, from 26″-32″. The area around the screen is preferably a bezel, dark or black in color or backlit with colored lights pulsing towards the center, and slanted in towards the display from the edges of the mount area (sides, top, and bottom of the cabinet where the display is mounted).

Continuing with box 502, the cabinet is to provide, in front of the mounted display, an area that is designed to allow placement of small personal items. It is intended that this area allow a person to place an item or items such as a wallet, chips, small handbag, coins, cards, bills, tickets, players cards, or a drink in front of them on the gaming machine cabinet. In one embodiment this will be a mostly flat area between the player inputs and the screen bezel area, from 4″-10″ deep. However, other configurations are fully contemplated, including without limitation providing additional depth, and/or forming a player deck area that is tilted towards a center area to guide spilled drinks, has a central flat area surrounded by a run-off area, or other configurations as functionally needed or as desired to create visual interest.

Moving into box 504, a gaming machine cabinet according to the present disclosure will be configured with a bolster or armrest at the outer edge of the player deck area. In one embodiment, the bolster will have more than one step or level (be multi-tiered), so that when resting an arm on the player deck, there is more than one contact point on which to rest, or, the player input devices are placed higher than the bolster so that a player's wrist does not need to twist as much to reach buttons, levers, etc. In another embodiment, the player deck area will be essentially flat and the edges of the player deck will have a resilient material attached thereon, to make a soft or compliant surface on with to rest elbows, arms, or wrists. A preferred embodiment is to further configure the player deck area so that a player may sit comfortably in a slightly forward leaning manner.

Continuing into box 506, also provided are side panels or wings which, in addition to purely decorative aspects, may also be configured to provide added privacy and visual focus. Visual focus is enabled by cutting off peripheral vision. When the player is seated in a slightly forward leaning position, the wings help cut off peripheral vision by extending visual cut-off past the ends of the main cabinet to the ends (edges) of the wings. Coupled with the overall cabinet design disclosed herein, a player may have most of their field of vision, including all their primary vision and most of their peripheral vision, enclosed by the cabinet. This enables greater focus on the game, and provides a feeling of privacy to a player. It also makes it significantly more difficult for passer-bys to see what the player is doing, including entering PINs for cards or similar activities. In addition, any personal items place on the player deck will be almost completely protected by the player's body, coupled with the wings. It would be difficult for another patron to walk off with any possession on the player's deck. In another embodiment, the side panels will further have slidable, extendable panels or curtains. This will enable a player to cut off their peripheral vision almost entirely, and will further protect their privacy and personal items from causal snatchers.

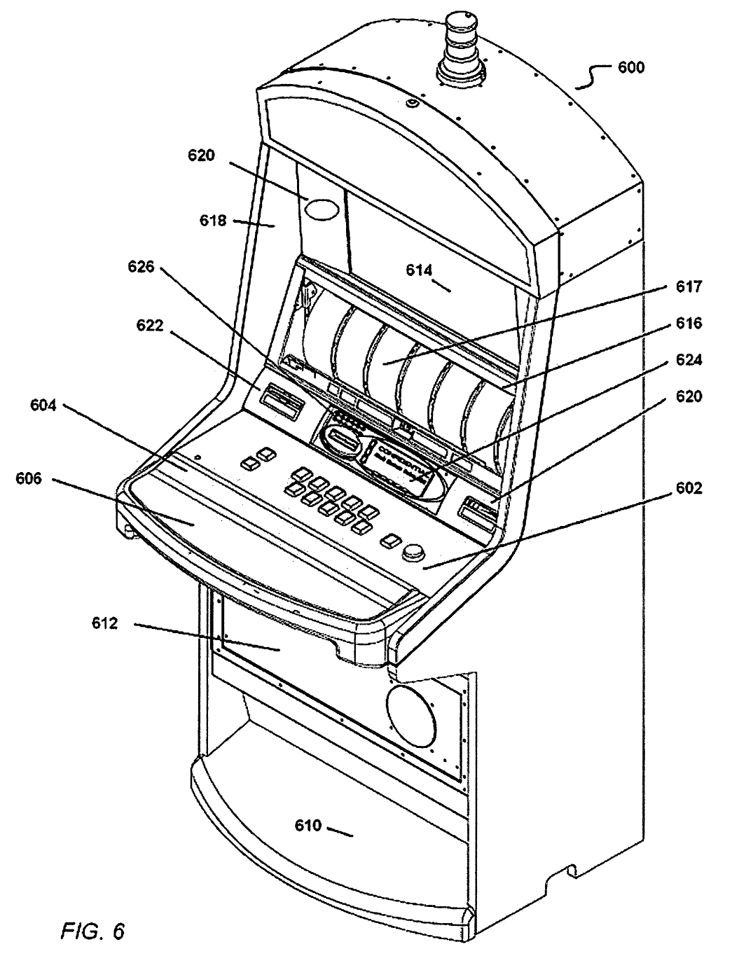

Referring to FIG. 6, gaming machine cabinet 600 includes player control area 602 (shown as a button deck, but can be any player input devices) with flat area or player deck 604. Player deck 604 may be used for drinks, ashtrays, food and any personal items that would be convenient to place in easy reach such as wallets, money, gaming chips, or pocketbooks. Armrest 606, shown as a stepped armrest, allows resting of arms, elbows and/or wrists while maintaining finger access to player input devices 602, players' possessions in player deck 604, and any other areas on or near the frontal area of gaming machine 600. Armrest 606 may be any configuration intended to enable comfortable resting of elbows, forearms, and wrists, etc. Gaming machine 600 enables this novel layout due to the space provided between the front of reel glass area 616, described further below, to the outer edge of armrest 606. In one embodiment this distance measures approximately 24 inches, with almost 17 inches of that space usable by a player (this includes player input area 602, player deck 604, and armrest 606). In the embodiment shown the areas are substantially flat, but other embodiments are fully contemplated such as having armrest 606 at varying angles relative to player deck 604, button deck 602 at varying angles relative to player deck 604, and player deck 604 in any configuration that provides the needed space to allow comfortable resting of arms, elbows, or wrists on the player deck bolster or armrest while interacting with the game input devices, and preferably allowing placement of small personal items. The player deck needs to have enough depth to allow, and preferably encourage, a slightly forward leaning position while using the gaming cabinet.

Also shown are typical gaming machine peripherals including bill acceptor 620, printer 622, card reader 624, and player tracking system and display 626 (preferably Bally Technologies' iView™ product). These devices are placed so that a player can see and, in most cases, operate them while resting his/her arms and/or wrists on armrest 606 of cabinet 600. Any set of gaming peripherals may be used with the gaming machine disclosed herein; shown is one exemplar embodiment.

Above player deck 604 is reel glass 616. In one embodiment, reel glass 616 may be a transparent essentially flat or curved panel constructed of glass, plastic, Plexiglas, Lexan or some similar material behind which electromechanical indicia-bearing reels 617 are displayed. While five reels 617 are illustrated, any number of reels may be mounted in cabinet 600. For example, various embodiments allow for the interchangeable mounting of 3-, 4-, 5-, 6-, 7-, 8- and 9-reel configurations in cabinet 600.

It is common for each reel to have a piece of material commonly known as a “reel strip” mounted about the reel periphery and upon which are displayed certain types of indicia such as representations of fruits (oranges, plums, lemons, cherries, etc.) arranged in particular patterns. Reel glass 616 is normally screen printed with masking graphics that create rectangular viewing windows aligned horizontally in front of each reel to allow a player to observe an aligned sequence of the indicia located on the reels. The forward edge of each reel mechanism is typically separated from the back face of the reel glass by distances of ¼ inch or more and it is common to be able to partially see the interior of the gaming machine cabinet and reel mechanisms through this space.

It is desirable to mask the internal structure of the reels from observation by the player in order to prevent distraction from the game and for aesthetic and security reasons. In accordance with one or more aspect of the invention, a reel shroud apparatus (not shown) may be mounted between reels 617 and reel glass 616 in order to offer individual reel illumination isolation and wider angle viewing of the reels. For example, one such reel shroud is disclosed in U.S. application Ser. No. 11/530,795, entitled “Gaming Machine Reel Shroud,” filed on Sep. 11, 2006, which is hereby incorporated by reference in its entirety for all purposes.

In one or more embodiments, reel glass 616 may be a transmissive liquid crystal video display (LCD), such as may be commercially available from LG Phillips LCD Co., Ltd., of Seoul, Korea. Such a display may allow the presentation of static or dynamic graphics adjacent to, or superimposed on reels 617. For example, pay line indicators, line bet indicators, award values, a pay table, special effects, bonus game graphics, player prompts or instructions and the like may be incorporated with the player's view of the indicia located on reels 617. In one or more embodiments, the transmissive LCD may be used to mask portions of one or more of reels 617 from the player's view during certain game conditions. In still other embodiments, the transmissive LCD may be combined with a touchscreen or touch glass input system, described further below.

Above reel glass 616, a flat panel display 614 is mounted. In one embodiment the display will be a DTV flat panel display having an aspect ratio of 16×9, such as 26″ LCD widescreen display mounted in landscape mode (positioned with its longer axis parallel to the deck areas). The display is preferably a high resolution LCD display, although lower resolutions may be used, and may incorporate a touch screen (not shown). Any touch screen technology may be used. The preferred embodiment of display 614 uses flat panel display technology (any type of flat panel technology may be used), as their use allows the gaming machine to have an overall depth, front-to-back, similar to gaming machines already in use. This gives the ergonomic cabinet described herein a footprint approximately equal to gaming machines already on casino floors. Although preferred, it is not required to make use of the ergonomic designs disclosed herein.

In one embodiment display 614 is slightly angled from vertical and is mounted on a hinged access panel. Peripheral vision distractions are further reduced by side panels or wings 618. In some embodiments wings 618 will be substantially flat, while in other embodiments wing 618 will have an internal dimension that encloses audio projection devices 620. In some embodiments the speakers are mounted inside the gaming machine cabinet 600 and one or more audio channels are used to carry the sound to openings in the wings 618. In other embodiments additional audio input devices (not shown) in the form of one or more microphones and output devices in the form of speakers or similar projection devices may be coupled to the gaming machine for the purposes of actively cancelling out distracting sounds from the surrounding environment using “cone of silence,” “beamed” sound or wave cancellation techniques. For example, samples taken from microphones positioned at various places on the cabinet 600 will be analyzed along with sounds known to be emanating from the game itself. Appropriate inverted signals will be issued from the sound cancellation devices to help prevent auditory player distractions.

Foot rest 610 is lower and flatter (7 to 10 degrees) than on existing gaming machine cabinets, promoting a forward leaning position rather than the typical backward lean of traditional upright gaming machines (traditional upright gaming machine footrests are angled around 25 degrees). In some embodiments, foot rest 610 is illuminated for safety and security. An illuminated graphic area 612 may also be provided below armrest 606 providing enhanced security for items the player may position near her/his feet.

As used herein, “player controls,” “input controls,” “input devices” and similar phrases refer to the controls a player will use while playing a game of chance (poker, reels, bingo, keno, etc.). This will typically be a button deck or button area located on a portion of the player deck, having one or more buttons used for on-going game play. Any type of player input devices are contemplated in combination with the player deck of the presently disclosed cabinet. This explicitly includes embodiments where the player controls may be touchscreen technologies on the main display, and where it is possible to have the ergonomic gaming cabinet disclosed herein having a player deck with no player input devices. The player controls may be used for various functions such as, but not limited to, selecting a wager denomination, selecting a game to be played, selecting a wager amount per game, initiating a game, or cashing out money from the gaming machine. For example, one input device is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand. Any player input device or combination of devices, for example, a track ball, joystick, touch screen system, touch pad, mouse, switches, toggle switches, or any other input means may be used to accept player input. Any type of player input devices are contemplated in combination with the player control areas 102 (FIG. 1) or 602 (FIG. 6) of the presently disclosed cabinets. This explicitly includes embodiments where the player controls may be touchscreen technologies on the main display, and where it is possible to have the gaming cabinet disclosed herein having no player input devices. Additionally, game display 616 may include a touch screen or touch glass system (not shown) to present player interfaces such as, but not limited to, touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference.

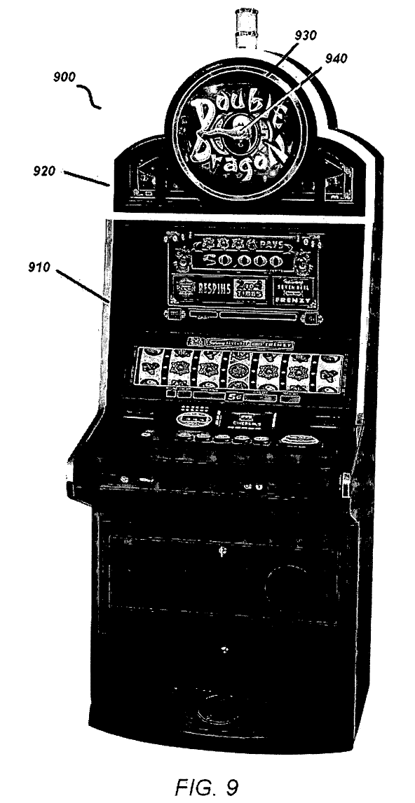

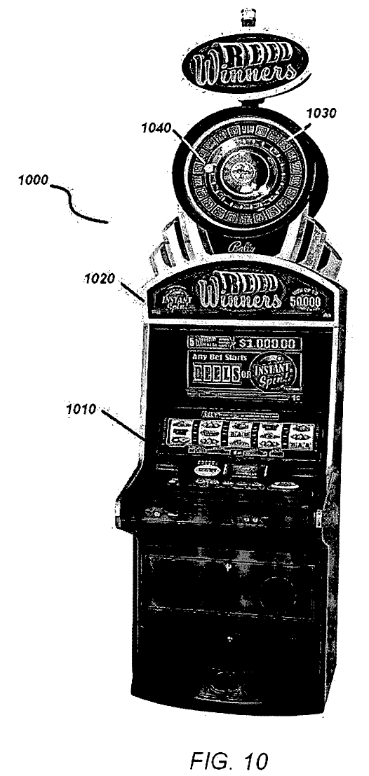

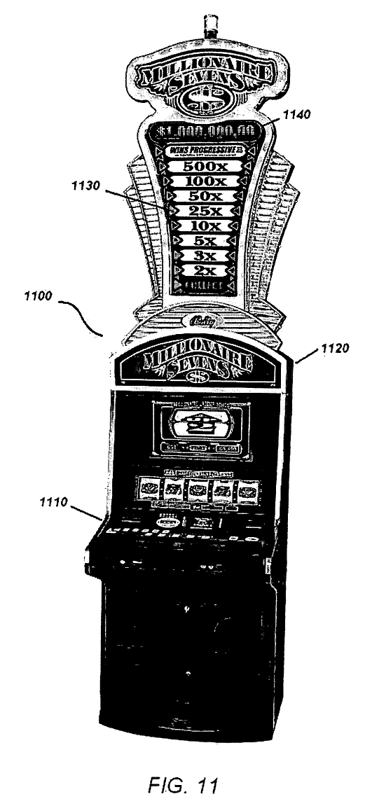

In accordance with one or more embodiments of the invention, FIG. 9 illustrates an ergonomic gaming machine 900 having a base section 910 and top box 920. Top box 920 includes game display 930 which may be used in addition to, or in conjunction with, the video and reel displays described above. Game display 930 includes a moving pointer or indicator 940 which may be used for primary or secondary game play on gaming machine 900. Similarly, in accordance with one or more other embodiments of the invention, FIG. 10 further illustrates an ergonomic gaming machine 1000 having a base section 1010 and top box 1020. Top box 1020 includes a game display including stationary wheel 1030 and a moving pointer or indicator in the form of a ball 1040 which may be used for primary or secondary game play on gaming machine 1000. In some embodiments, wheel 1030 is a moving wheel and indicator 1040 may be a fixed pointer. Top box game displays may take other forms. For example, in accordance with still other embodiments, FIG. 11 illustrates ergonomic gaming machine cabinet 1100 having base section 1110 and top box 1120 which includes a light box 1130 and progressive meter 1140.

In some embodiments, the game played on displays such as display 930, wheel 1030 and light box 1130 may be associated with a trigger related to a game played on one or more of the displays in base cabinets 910, 1010 or 1110. In other embodiments, the game played on display 930, wheel 1030 or light box 1130 may not be associated with a primary game trigger, but may be one of a set of primary games randomly selected for play following initiation of play by the player. For example, multiple primary games are disclosed in U.S. application Ser. No. 11/428,220, entitled “Multiple Primary Games Triggered by Random Number Generator,” filed on Jun. 30, 2006, which is hereby incorporated by reference, in which a gaming machine has at least two distinct primary games. After receiving a wager, the gaming machine determines which primary game to activate. The selected primary game is activated and a game outcome is presented to the player on its respective game display or displays.

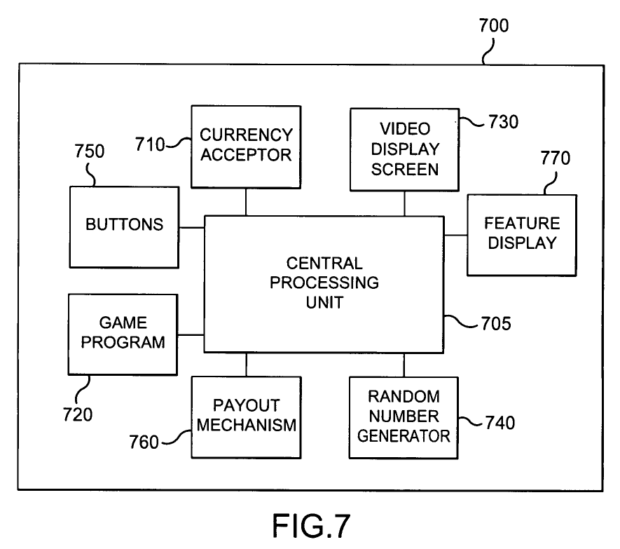

In accordance with one embodiment of the present invention, FIG. 7 is a block diagram showing the interconnection of the physical and logical components 700 of gaming machines 100 (FIG. 1) and 600 (FIG. 6). Currency acceptor 710, for example, a JCM American Corporation Model WBA, is typically connected to a conventional central processing unit (“CPU”) 705, such as an Intel Pentium microprocessor mounted on a gaming motherboard, by a serial connection such as RS-232 or USB. Other manufacturers of the CPU may be, for example, one of those commercially available from companies such as Sun Microsystems or AMD. The gaming motherboard may be mounted with other conventional components, such as are found on conventional personal computer motherboards, and loaded with a gaming machine operating system (OS), such as an Alpha OS by Bally Technologies. CPU 705 executes game program 720 that causes video display screen 730 and/or reels 770 to display a game.

When a player has inserted a form of currency such as, for example and without limitation, paper currency, coins or tokens, cashless tickets or vouchers, electronic funds transfers or the like into currency acceptor 710, a signal is sent to CPU 705 which, in turn, assigns an appropriate number of credits for play. The player may further control the operation of gaming machine 100 or gaming machine 600, for example, to select the amount to wager via electromechanical or touchscreen buttons 750. The game starts in response to the player pushing one of buttons 750 or an alternate start mechanism such as a handle or touchscreen icon (not shown). Random number generator 740 responds to instructions from CPU 705 to provide a display of randomly selected indicia on video display screen 730. In some embodiments, random generator 740 may be physically separate from gaming machine 700; for example, it may be part of a central determination host system (not shown) which provides random game outcomes to CPU 705. Thereafter, the player may or may not interact with the game through electromechanical or touchscreen buttons 750 to change the displayed indicia. Finally, CPU 705 under control of game program 720 compares the final display of indicia to a pay table. The set of possible game outcomes may include a subset of outcomes related to the triggering of a feature game. In the event the displayed outcome is a member of this subset, CPU 705, under control of game program 720, may cause feature game play to be presented on video display screen 730 or reels 770.

In one embodiment, reels 770 are electromechanical reels. Game program 720 includes reel spinning firmware to provide proper signals for driving multiple stepper motors (not shown), which, in turn, spin the reels 770. Preferably, the motors are driven using a “full step” excitation sequence in which a single motor step is preformed by changing the excitation on one of the two-phase inputs in a specified sequence. The sequence determines whether the direction implemented is forward or reverse. The reel drive pulse trains go through three distinct stages: acceleration, steady state, and deceleration. During acceleration, reels 770 are driven with a pulse frequency that is less than the maximum “start/stop” frequency. Typically, if a motor is attempted to be started with a high frequency pulse, the motor loses synchronization and slips. Therefore, preferably the drive frequency is incrementally increased until the steady state drive frequency is reached. At steady state, reels 770 are driven for a specified number of steps at the maximum drive frequency before going to the deceleration phase. During deceleration, the process is reversed and the drive frequency decreased until the stopping frequency is reached. Preferably, this procedure helps to prevent reels 770 from slipping past the proper stop position on deceleration. Finally, at the stopping point, the motor excitation signals are held constant.

Predetermined payout amounts for certain outcomes, including feature game outcomes, are stored as part of game program 720. Such payout amounts are, in response to instructions from CPU 705, provided to the player in the form of coins, credits or currency via payout mechanism 760, which may be one or more of a credit meter, a coin hopper, a voucher printer, an electronic funds transfer protocol or any other payout means known or developed in the art.

In various embodiments of gaming machine 700, game program 720 is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 700 are stored in the same or a separate memory device (not shown). Some or all of game program 720 and its associated data may be loaded from one memory device into another, for example, from flash memory to random access memory (RAM).

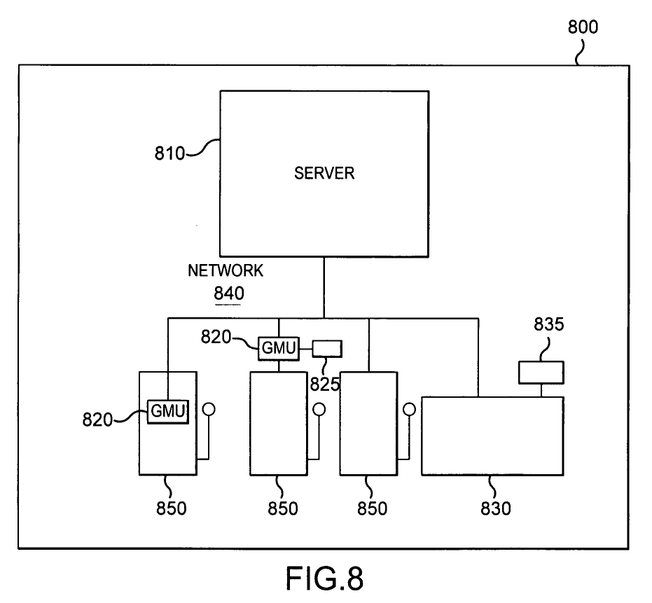

Referring to FIG. 8, in accordance with one aspect of the invention, gaming system 800 includes host computer or server 810, gaming machines 850, and network 840 connecting gaming machines 850 to server 810. Additionally, gaming display computer 830 is shown connected to network 840. Server 810 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 810 may be configured as a single “logical” server that comprises multiple physical servers or host computers. Gaming machines 850 operate similar to conventional peripheral networked terminals. Gaming machines 850 have a player interface such as a display, a card reader, and selection buttons through which gaming machines 850 interact with a player playing a wagering game. The player interface is used for making choices such as the amount of a bet or the number of lines to bet. Gaming machines 850 also provide information to server 810 concerning activity on gaming machines 850 and provide a communication portal for players with server 810. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 850 may be an electromechanical reel spinning slot machines in accordance with the various embodiments of the invention described above, or, for example, a more traditional electromechanical slot machine, a video slot machine, a video poker machine, a keno machine, a video blackjack machine, or other gaming machine. Networking components (not shown) facilitate communications across network 840 between the system server 810 and game management units 820 and/or gaming display control computers 830 that control displays for carousels of gaming machines. Game management units (GMU's) 820 connect gaming machines to networking components and may be installed in the gaming machine cabinet or external to the gaming machine. The function of the GMU is similar to the function of a network interface card connected to a desktop personal computer (PC) and it may contain tracking software which provides notification to the casino of certain events on a gaming machine 850, including wins. Depending upon the casino management system, payouts on large wins at gaming machines 850 may be made directly to a player account managed by the host computer; in which case, the player is notified by way of the GMU at gaming machine 850 that the player's account has been credited.

Some GMU's have much greater capability and can perform such tasks as presenting and playing a game using a display 825 operatively connected to GMU 820. In one embodiment, GMU 820 is a separate component located outside the gaming machine. Alternatively, in another embodiment, the GMU 820 is located within the gaming machine. In one embodiment, display 825 comprises a transmissive reel glass display 616, described above, wherein system-based information, menus or games may be displayed on the reel glass as desired or needed. Optionally, in an alternative embodiment, one or more gaming machines 850 connect directly to the network and are not connected to a GMU 820. Displays related to games offered on gaming machines 850 or GMU displays 825 may also be presented on gaming display 835 by gaming display control computer 830. An example of a display control computer is disclosed in U.S. application Ser. No. 11/463,793, entitled “Reconfigurable Gaming Display and System,” filed on Aug. 10, 2006, which is hereby incorporated by reference in its entirety.

A gaming system of the type described above also allows a plurality of games in accordance with the various embodiments of the invention to be linked under the control of server 810 for cooperative or competitive play in a particular area, carousel, casino or between casinos located in geographically separate areas.

One will appreciate that a gaming system may also comprise other types of components, and the above illustrations are meant only as examples and not as limitations to the types of components or games used in networked gaming machines in accordance with the various embodiments of the invention. Additionally, it may further be appreciated that each of the games above could be operated on a remote host computer such that a player initiates play with the host computer over a network via the player interface and gaming machine 850 operates the respective gaming, reel and video displays in conjunction with the game whose play is controlled by the remote computer.

In accordance with one or more embodiments of the invention, slot machines 850 may be connected to a plurality of progressive controllers or progressive systems including wide-area progressive systems, casino-wide progressive systems, a local bank progressive system or a combination thereof. A wide-area progressive system, such as the MAPS system by Bally Technologies, may encompass a large number of gaming machines across an entire state, region or set of regions and will generally offer the highest value progressive jackpots, typically in the millions of dollars. A casino-wide progressive system may be local to a specific property and have several connected gaming machines and offer progressive jackpots in the thousands of dollars. Still other progressive systems, such as a local bank progressive system, are much smaller and typically link a bank of gaming machines together for a progressive jackpot in the hundreds of dollars. Local bank progressive systems may be connected to a known industry-standard progressive controller (not shown) such as a controller manufactured by Mikohn, Inc. The progressive controller monitors wagering during regular play at each of the gaming machines connected to the controller, calculates a current value for one or more progressive jackpot pools and transmits the current pool values to the gaming machines. In one or more embodiments, progressive awards are accumulated during regular play as a percentage, such as three percent, of the regular game play take. The prizes may be sized according to the preferences of the casino operator. The number of prizes may vary without deviating from the scope of the invention. The size of the prizes is dependent on the amount of play prior to initiating feature game play. In another aspect, the prizes may be set amounts established by the casino operator from non-coin-in funds, such as marketing funds. The smallest of the progressive systems are a single gaming machine which manages its own progressive jackpot, typically in the tens of dollars. In one or more embodiments, one or more of the various types of progressives may also be operated by the player tracking host computer or server 810.

Although the description above contains certain specificity, the described embodiments should not be construed to indicate the scope of the invention; the descriptions given are providing an illustration of certain preferred embodiments of the invention. The scope of this invention is determined by the appended claims and their legal equivalents.

What is claimed:

1. A networked gaming system including:
a plurality of gaming machines connected through a network to at least one server, at least one of the gaming machines including a cabinet comprising a top, bottom, back, two opposite sides, and a front, the front comprising a first display mounted substantially vertically;
a second display comprising a reel glass and one or more electromechanical reels;
a first surface area stably receivable for small personal items between the second display and at least one player input device;
a second surface area configured to allow resting of an arm, elbow, or wrist, the second surface area on an opposite side of the player input device as the first surface area;
wherein the cabinet houses gaming electronics and logic to enable the player input device to be usable to play a game whose outcome is at least partially based on a random event.

2. The gaming system of claim 1 wherein the at least one gaming machine further comprises a reel shroud positioned between the reel glass and the electromechanical reels.

3. The gaming system of claim 1 wherein the reel glass comprises a transmissive liquid crystal display.

4. The gaming system of claim 1 wherein said first display is mounted from 0 degrees to 20 degrees from vertical.

5. The gaming system of claim 1 wherein said first surface area comprises at least 6 inches from said second display to said at least one player input device.

6. The gaming system of claim 1 wherein said second surface area further comprises a resilient bolster.

7. The gaming system of claim 1 wherein said second surface extends at least 3 inches beyond any player input devices.

8. The gaming system of claim 1 where said cabinet further comprising side panels extending outwardly from and on each side of at least one of said displays.

9. The gaming system of claim 1 further comprising a top box attached to the cabinet.

10. The gaming system of claim 10 wherein the top box comprises a game display.

11. The gaming system of claim 11 wherein the game display comprises a wheel.

12. The gaming system of claim 12 wherein the wheel is a stationary wheel.

13. The gaming system of claim 12 wherein the wheel is a moving wheel.

14. The gaming system of claim 1 further comprising a game management unit operatively coupled to at least one of the gaming machines and to the network.

15. The gaming system of claim 1 wherein the gaming machines are connected for competitive play.

16. The gaming system of claim 1 where the gaming machines are connected for cooperative play.

17. The gaming system of claim 1 wherein the game outcomes is determined by one or more servers.

18. The gaming system of claim 1 further comprising at least one progressive controller connected to at least one of the gaming machines.

19. The gaming system of claim 1 further comprising at least one progressive controller connected to at least one server.

20. The gaming system of claim 1 further comprising at least one of a wide-area progressive, casino-wide progressive, bank progressive, stand-alone progressive, or a combination thereof.
